(19) United States
(12) Patent Application Publication
(10) Pub. No.: US 2007/0133055 A1
(43) Pub. Date: Jun. 14, 2007

(54) Electronic photo book

(76) Inventor: Okorie A. Johnson, Silver Spring, MD (US)

Correspondence Address: Eric G. King;Miles & Stockbridge, P.C., Suite 500, 1751 Pinnacle Drive, McLean, VA, 22102-3833, US

(21) Appl. No.: 11/297,477

(22) Filed: Dec. 9, 2005

(51) Int. Cl. G06K 15/00

(52) U.S. Cl. 358/1.18; 358/302

(57) ABSTRACT

An electronic photo book for storing and displaying digitized images. The electronic photo book includes two displays each having a top half and a bottom half in which individual images are displayed in each half.

This disclosure contains information subject to copyright protection. The copyright owner has no objection to the facsimile reproduction by anyone of the patent disclosure or the patent as it appears in the U.S. Patent and Trademark Office files or records, but otherwise reserves all copyright rights whatsoever.

### BACKGROUND

1. Field of Invention

The present invention relates to the field of displays and, more specifically, methods and apparatuses for storing and displaying digitized images.

2. Description of Related Art

Technological advances have resulted in electronic components having greatly increased storage capacity and processing bandwidth being available for use in electronic devices. At the same time, the physical size and power requirements for such components have continued to decrease. These developments have made it possible for various forms of information to be represented, stored, and displayed in digital form using consumer electronics devices. For example, photographs are now able to be digitized (i.e., a photographic image can be converted to a digital representation using binary digits (bits)) and then processed, stored, and output for display using electronic devices.

However, existing devices that store and display digitized images, such as, for example, digitized photographs, have drawbacks. For example, persons who are used to traditional book-style photo albums can find it difficult to adjust to using a consumer electronic device for viewing digitized photographs or images. Consumer electronics devices capable of displaying digitized photographs or images tend to either have inadequate screens that are, for example, small relative to an individual sheet of a traditional paper photo album, or tend to be too expensive to support mass market consumer adoption. For multiple users to view images on the smaller displays of some consumer devices requires the users to huddle uncomfortably close together in order for all users to be able to view the image(s). In some cases, it may not be possible for each user to see the image(s) at the same time, requiring the consumer electronics device to be passed around among the users who then view the display individually. These limitations decrease the usefulness and desirability of such consumer devices.

Furthermore, the user may be less comfortable in using an electronic device to view images as compared with the familiar use of the traditional paper photo album. In some cases, users can find the procedures for consumer electronics devices to be unfamiliar and even cumbersome. This can be particularly true for segments of the consumer population who are not technologically inclined.

In addition, the user may prefer the look and feel of the traditional bound paper-based photo album to modernly-styled consumer electronics devices. However, it is desirable to provide the user with the benefits available through the use of electronics such as, for example, the ability to store large amounts of photographs using less physical space than multiple paper-based photo albums, the ability to quickly locate a particular photograph among many photographs or images, the ability to store photographs without image degradation over time, and the ability to share images with other users electronically.

Thus, there is a need for systems and methods to address these limitations as well as others readily discernable from review of this disclosure.

### SUMMARY

Embodiments are directed generally to an electronic photo book for storing and displaying digitized photographs. In various embodiments, the electronic photo book can comprise two displays each having a top half and a bottom half in which individual photographs are displayed in landscape fashion.

In particular, various embodiments can comprise an electronic photo book comprising a first display coupled to a processor via a first display interface and a second display coupled to the processor via a second display interface. The first display and the second display can each comprise an output display area, at least two sides, and an exterior portion. Various embodiments can further comprise a spine with two sides and an exterior portion. The spine can be hingably connected to a first side of the first display along a first side of the spine and also hingably connected to one side of the second display along a second side of the spine, such that the two displays can be opened and closed in the manner of the pages of a book.

In various embodiments, the exterior portions of the first and second displays and the spine can be covered with a tactile material such as leather or vinyl. The display area of each display can comprise a top half and a bottom half.

The processor can be disposed or located within the spine and can be configured to output a single digitized photograph to the top half and to the bottom half of the display area of the first and the second displays.

Various embodiments can further comprise a fold-in cushion inlay covered with a soft material such as, for example, felt. The fold-in cushion inlay can be hingably connected to a second side of the first display.

It is to be understood that both the foregoing general description and the following detailed description are exemplary and explanatory only and are intended to provide a further explanation of the present teachings, as claimed.

These and other features of the present teachings are set forth herein.

### BRIEF DESCRIPTION OF THE DRAWINGS

The utility, objects, features and advantages of the invention will be readily appreciated and understood from consideration of the following detailed description of the embodiments of this invention, when taken with the accompanying drawings, in which same numbered elements are identical and:

FIG. 1A is an open-book front elevational view of an electronic photo book according to various embodiments;

FIG. 1B is an open-book back elevational view of an electronic photo book according to various embodiments;

FIG. 1C is a cross-sectional side view of an electronic photo book according to various embodiments;

FIG. 2 is a schematic block diagram of an electronic photo book according to various embodiments;

FIG. 3 is a flow chart of a display method according to various embodiments;

FIG. 4 illustrates a set of user display controls according to various embodiments; and

FIG. 5 is an example mode selection menu according to various embodiments.

### DETAILED DESCRIPTION

Various embodiments can comprise systems and methods for storing and displaying digitized images such as, for example, photographs. For example, various embodiments can comprise an electronic photo book for displaying digitized images or photographs. In various embodiments, the electronic photo book can comprise two displays each having a top half and a bottom half in which individual images or photographs are displayed in landscape or portrait fashion. Landscape fashion, as discussed herein, refers to an orientation of a photograph in which the width of the photograph is longer than the height as displayed. Landscape fashion is to be distinguished from portrait fashion, which is the opposite of landscape fashion: Photographs displayed in portrait fashion are oriented to have a height that is longer than the width of the photograph.

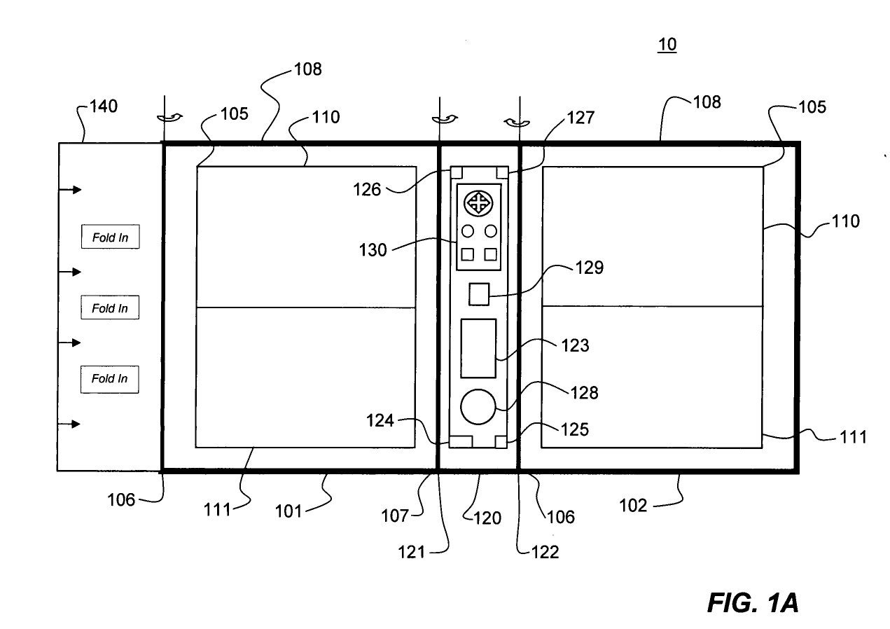

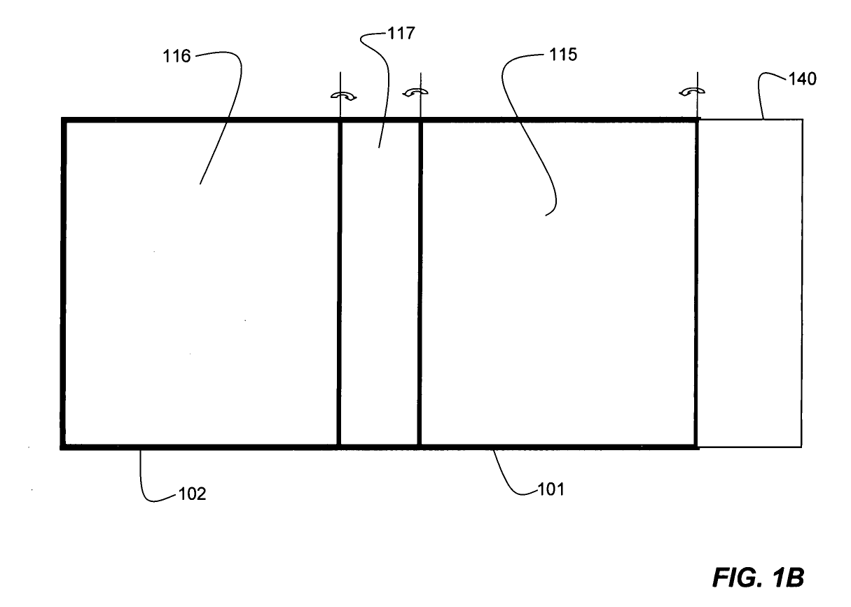

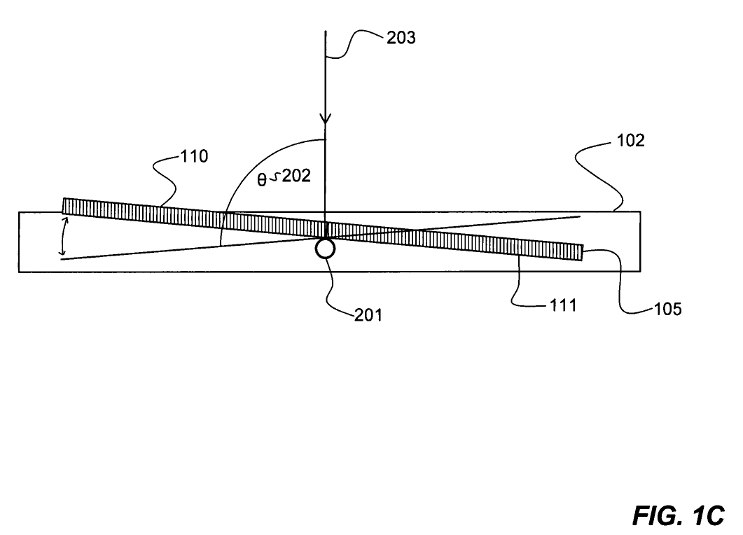

With respect to FIG. 1A, there is shown an open-book (i.e., open position) front elevational view of an electronic photo book 10 according to various embodiments. As shown in FIG. 1, the electronic photo book 10 can comprise a first display 101 hingably connected to a spine 120 and a second display 102 also hingably connected to the spine 120. The term “hingably connected” as used herein means that two structures so connected are capable of rotational movement with respect to each other about an axis formed at the intersection of the two structures along a line comprising points of connection. Thus, as shown in FIG. 1A, the displays 101 and 102 can be rotated or folded inwardly toward each other to a closed position and, conversely, can be rotated of opened outwardly with respect to each other to an open position, in the manner or opening or closing a book.

In various embodiments, the first display 101 and the second display 102 can each comprise an output display area 105, a left side 106, and a right side 107, and an exterior portion 108. The spine 120 can comprise two sides 121 and 122. In various embodiments, as shown in FIG. 1A, the spine 120 can be hingably connected to the right side 107 of the first display 101 along a first side 121 of the spine 120, and the spine 120 can also be hingably connected to the left side 106 of the second display 102 along a second side 122 of the spine 120. The displays 101 and 102 and the spine 120 can be formed of a rigid, lightweight material. For example, in various embodiments, the displays 101 and 102 and the spine 120 can be formed of a resin material such as a plastic. The first display 101 can comprise a first display means, and the second display 102 can comprise a second display means, respectively.

As shown in FIG. 1A, in various embodiments the display area 105 of the first display 101 and the second display 102 can comprise a top half 110 and a bottom half 111. In various embodiments, the electronic photo book 10 can be configured to output (or display) a single digitized photograph or image using to the top half 110 and the bottom half 111. That is, up to four digitized photographs or images can be output or displayed at the same time, one each output to the top half 110 of the first display 101, the bottom half 111 of the first display 101, the top half 110 of the second display 102, and the bottom half 111 of the second display 102. Each of the output photographs or images can be different, the same, or a combination thereof. Thus, the halves 110, 111 of the first display 101 and the second display 102 taken together can each comprise a display quadrant.

In various embodiments, the top half 110 and the bottom half 111 can each comprise a rectangular Liquid Crystal Display (LCD) screen disposed in landscape orientation one above the other in each of the two open pages of the leather electronic photo book 10. Each display area can be configured to operate primarily as two independent north/south halves 110, 111 so that the default display for the electronic photo book 10 in the open position is four pictures (or photographs or images), each measuring about five inches by seven inches. Controls 130 on the spine 120 allow each half 110, 111 to “zoom out” of an album to display more pictures (for example, 2, 4, 8, or 16 photographs or images) up to 16 images in each of the halves 110, 111 to create a 32 thumbnail picture survey per display area 105 of the entire library or a particular digital album. In response to input received from the controls 130, each half 110, 111 of the display area 105 can also “zoom in” so that each display area 105 contains only one picture, photograph, or image oriented in landscape so the book 10 must be turned 90 degrees to the right or left in order to view a picture as the entire screen.

In addition, each display area 105 can also “zoom in” further for a digital zoom. For example, various embodiments can provide the user with the capability to optically or digitally “zoom in” on particular portions of an image displayed in any of the halves 110, 111 using the controls 130. The user can operate the “zoom in” feature to view the particular portion of the image in a magnified view such that the displayed portion is enlarged relative to other portions of the image. This permits the user to observe greater detail for the displayed portion than is possible when viewing the entire image.

Furthermore, various embodiments can comprise the capability to display one or more images or photographs in each half 110, 111 in portrait fashion as well as landscape fashion. In various embodiments, the user can select the image orientation between landscape and portrait using the controls 130.

In various embodiments, the displays 101 and 102 can output photographs, pictures, or images that are stored and formatted according to the Joint Photographic Experts Group (JPEG) or the Moving Picture Experts Group (MPEG) standards.

In various embodiments, the electronic photo book 10 can further comprise a fold-in cushion inlay 140, as shown in FIG. 1A. The fold-in cushion inlay 140 can comprise a rigid, lightweight material covered with a soft material. For example, the fold-in cushion inlay 140 can comprise a resin material such as a plastic covered by felt. As shown in FIG. 1A, the fold-in cushion inlay 140 can be hingably connected to the left side 106 of the first display 101. Thus, as shown in FIG. 1A, the fold-in cushion inlay 140 can be rotated or folded inwardly toward the first display 101 in a closed position and, conversely, can be rotated of opened outwardly with respect to the first display 101 to not obscure the display area 105 of the first display 101 when the electronic photo book 10 is in the open position. Thus, in various embodiments, the first display 101 (for example, left page) of the electronic photo book 10 can be attached to the fold-in cushion inlay 140 to protect the components of the electronic photo book 10 in the closed position to allow a user to safely transport or carry the electronic photo book 10.

Furthermore, by providing two displays each with two independently controllable halves, various embodiments can allow a group of users to view digitized photographs or images at the same time without having to crowd together to view a single display.

In various embodiments, the spine 120 can comprise an information display 123 disposed in the spine 120 as shown in FIG. 1A. The information display 123 can be configured to output information associated with the photographs available for display such as, for example, but not limited to, the number of albums available, the amount of storage space remaining available, and the remaining battery life for the electronic photo book 10.

As shown in FIG. 1A, the electronic photo book 10 can further comprise a power port 124 configured to receive power from an external source and to recharge a battery used to power the electronic photo book 10. In various embodiments, the electronic photo book 10 can comprise a lightweight battery supply such as, for example, a Lithium battery. Furthermore, the electronic photo book 10 can also comprise a download port 125 configured to receive digital information from an external device or network. The electronic photo book 10 can also comprise a printer port 126 configured to output digitized photographs to an external printer upon user selection using the power/mode button 128. The electronic photo book 10 can also comprise a wireless interface 127 such as, for example, an infrared interface, configured to output digitized photographs to an external display device such as, for example, a Personal Computer (PC), PC display or monitor, television, or television screen. In various embodiments, the electronic photo book 10 can further comprise a camera flash drive 129 configured to read and write to a digital camera memory device.

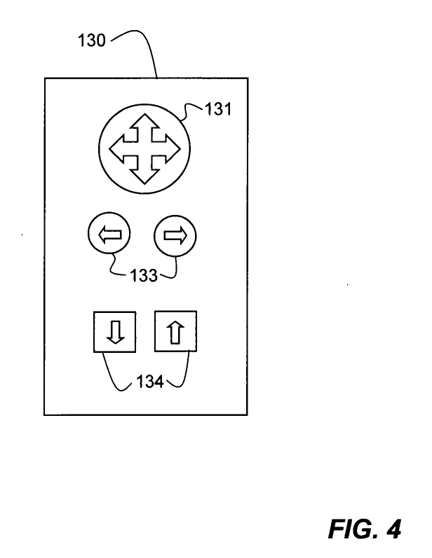

In various embodiments, the electronic photo book 10 can also comprise user display controls 130. With respect to FIG. 4, there is shown a set of user display controls 130 according to various embodiments. As shown in FIG. 4, the user display controls 130 can comprise an up/down and left/right selection button 131 . Further, user display controls 130 can comprise advance and retreat buttons 133 and quantity buttons 134.

In various embodiments, the power port 124, download port 125, printer port 126, wireless interface 127, power/mode button 128, and camera flash drive 129 can be located in or disposed in the spine 120 between the displays 101 and 102 for easy user access in the open-book position. Alternatively, the camera flash drive 129 can be located on an edge of the spine 120 such that the memory medium can be inserted into and removed from the camera flash drive 129 in a direction parallel to the length of the spine 120, to allow the spine to have a small depth relative to its height and width.

With respect to FIG. 1B, there is shown an open-book (i.e., open position) back elevational view of the electronic photo book 10 according to various embodiments. As shown in FIG. 1B, the displays 101 and 102 can comprise exterior back portions 115 and 116, respectively. Similarly, the spine 120 can comprise an exterior back portion 117. In various embodiments, the exterior back portions 115, 116, and 117 can comprise a tactile material. For example, in various embodiments, the exterior back portions 115, 116, and 117 can comprise a leather covering. In various alternative embodiments, the exterior back portions 115, 116, and 117 can comprise a coating of a synthetic material such as, for example, a polyvinyl coating. Other coatings of such tactile materials are possible.

With respect to FIG. 1C, there is shown a cross-sectional side view of the electronic photo book 10 according to various embodiments. As shown in FIG. 1C, the electronic photo book 10 can comprise a fulcrum rod 201 upon which the display area 105 is rotationally mounted within the display 101 and 102. In various embodiments, the display area 105 can be rotated by hand about an axis provided by the fulcrum rod 201 to change a display angle θ 202 of the halves 110, 111 relative to the user's direction of view 203. Thus, various embodiments can provide the user the capability to rotate the display area 105 about the fulcrum rod 201 to avoid glare or to compensate for angle of view limitations of the display area 105 device.

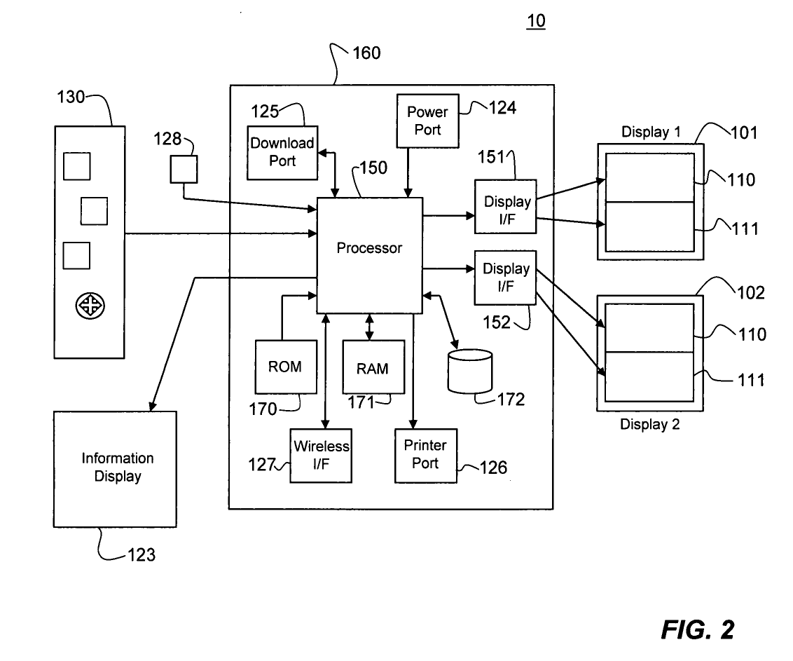

With respect to FIG. 2, there is shown a schematic block diagram of the electronic photo book 10. As shown in FIG. 2, the first display 101 can be coupled to a processor 150 via a first display interface 151 and the second display 102 can be coupled to the processor 150 via a second display interface 152. In various embodiments, the processor 150 can be disposed within the spine 120. In various embodiments, the processor 150 and the display interfaces 151 and 152 can be configured to independently control the top half 110 and the bottom half 111 of each of the displays 101 and 102, as shown in FIG. 2. Further, the processor 150 and the display interfaces 151 and 152 can be configured to output a single digitized photograph to the top half 110 and to the bottom half 111 of the display areas 105 of the first display 101 and the second display 102. The processor 150 can be any commercially available processor, controller, or microcontroller capable of executing a sequence of programmed instructions to control its operations and input/output. For example, the processor 150 can be a Pentium® processor available from Intel Corporation of Santa Clara, Calif. The processor 150 can comprise a processing means.

In various embodiments, the display interfaces 151 and 152 can each comprise a memory for storing a bit map image representation of the image to be output to the halves 110 and 111. That is, for example, the display interfaces 151 and 152 can comprise two memory portions. For example, the display interface 151 can comprise a first memory portion to contain a bit map representation of the top half 110 of the first display 101 and a second memory portion to contain an bit map representation of the bottom half 111 of the first display 101. Similarly, the display interface 152 can comprise a first memory portion to contain a bit map representation of the top half 110 of the second display 102 and a second memory portion to contain an bit map representation of the bottom half 111 of the second display 102. The display interfaces 151 and 152 can further comprise electronic conversion circuitry to convert the stored bit map information to Red-Green-Blue (RGB) inputs to the displays 101 and 102 to cause the displays 101 and 102 to output the user-viewable images represented by the binary information stored in the bit map memory locations to each half 110, 111. The processor 150 can be configured to load and manipulate the bit map information of the display interfaces 151 and 152 in response to user input received via the controls 130.

In various embodiments, the information display 123 can be coupled to the processor 150. The information display 123 can comprise a Liquid Crystal Display (LCD) device. The information display 123 can display lines of text. The information display 123 can be disposed in the spine 120. The processor 150 can be configured to output information to the information display 123 to inform the user about various status items concerning the electronic photo book 10. For example, the processor 150 can be configured to output one or more text messages to the information display 120 associated with names and number of albums, the photographs available for display comprising the number of albums available, the amount of storage space remaining available, and the remaining battery life for the electronic photo book 10, for example. The information display 123 can comprise an information display means. Further, the display controls 130 can be coupled to the processor 150.

In various embodiments, the power port 124 can be coupled to the processor 150 and configured to receive power from an external source. For example, the power port 124 may be configured to allow the electronic photo book 10 to be powered by an external Alternating Current (AC) power source such as, for example, but not limited to, standard household wiring or an AC power adapter for an automobile, boat, or other such source. The power port 124 can also be configured to recharge the electronic photo book 10 batteries (not shown). The power port 124 can comprise a power receiving means.

In various embodiments, the download port 125 can be coupled to the processor 150 and configured to receive digital information from an external device or network. For example, the download port 125 can comprise a Universal Serial Bus (USB) port capable of connection to a PC, digital camera, flash memory device (such as, for example, the Memory Stick PRO™ 512MB device available from Lexar Media, Inc. of Fremont, Calif.), or a scanner. The processor 150 can receive digital information, such as digitized photographs and images, for a PC, scanner, or other USB-enabled device via the download port 125. In various alternative embodiments, the download port 125 can comprise an IEEE 1394 Firewire™ port. The download port 125 can comprise a download means.

The printer port 126 can be coupled to the processor 150 and configured to output digitized photographs to a printer, such as a photograph printer available from various suppliers. In various embodiments, the processor 150 can be configured to output a selected photograph or image to the external printer via the printer port 125 upon user selection using the power/mode button 128. In various embodiments, either individual images or a range of pictures can be sent to the attached printer. In various embodiments, the printer port 126 can comprise a USB port. The printer port 126 can comprise a printer interface means.

The wireless interface 127 can be coupled to the processor 150 and configured to output digitized photographs to an external display device such as, for example, a Personal Computer (PC), PC display or monitor, television, or a television screen. In various embodiments, the wireless interface 127 can comprise an infrared interface. In various alternative embodiments, the wireless interface 127 can comprise a Wireless LAN (WLAN) interface configured for communication in accordance with, for example, the Institute of Electrical and Electronics Engineers (IEEE) 802.11 standard. Other interface standards can also be supported. Thus, the wireless interface 127 can be used to receive and send digitized photographs or images to other electronic photo books, to one or more laptop PCs, PDAs, or TV adapters. The wireless interface 127 can comprise a wireless interface means.

In various embodiments, the wireless interface 127 can comprise an interface to a packet-switched network. For example, the wireless interface 127 can comprise an interface to a Transmission Control Protocol/Internet Protocol (TCP/IP) network. In various embodiments, the network can be a public network such as, for example, the Internet. Alternatively, the network can be, without limitation, a BlueTooth™ network, a telephone landline based modem or a wireless network such as a cellular digital packet data (CDPD) network or a wireless local area network (WLAN) provided in accordance with, for example, the IEEE 802.11 standard, Global System for Mobile communications (GSM) Generalized Packet Radio Service (GPRS) and variations thereof, an optical communications network, or other such communications network capable of transporting packet-based information. Other networks may also be used.

In various embodiments, the power/mode button 128 can comprise a two-position push button switch. The power/mode button 128 can also be coupled to the processor 150. In various embodiments, user actuation of the power/mode button 128 be used to power up and to shut off the electronic photo book 10. When the electronic photo book 10 is powered on, user actuation of the power/mode button 128 can cause the processor 150 to perform operations in accordance with one of a variety of operating modes. Such operating modes for the electronic photo book 10 can comprise, for example, but not limited to, a select digital album mode, a download images mode, a print images mode, and a beam/receive images mode. Other modes are possible.

Operation of the power/mode button 128 is described as follows. When the electronic photo book 10 is in a power off state, user actuation of the power/mode button 128 can cause power to be applied to the electronic components of the electronic photo book 10. Upon entering a power on state, the processor 150 can be configured to output to the display 101 a list of operating modes for user selection. In various embodiments, the displayed list of operating modes can comprise a character generated dialog box. In addition, the processor 150 can be configured to output the modes for selection using the display 101 as a default. The user can cause the processor 150 to output the modes to the display 102 instead, according to user preference.

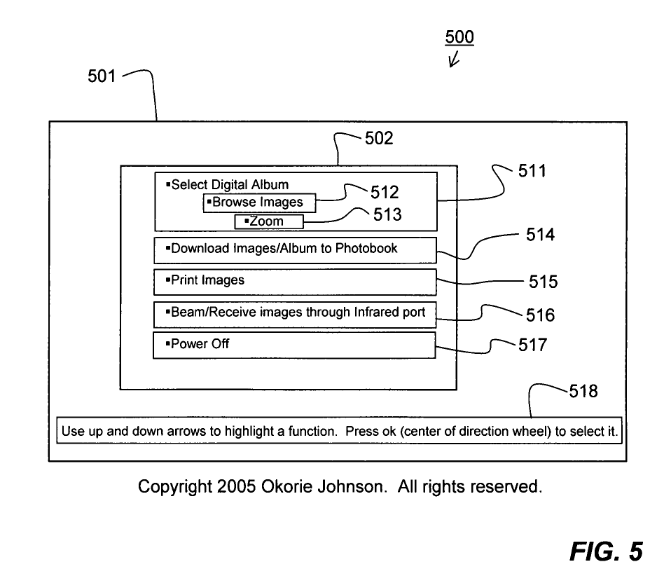

With respect to FIG. 5, there is shown an example mode selection menu 500 according to various embodiments. As shown in FIG. 5, the mode selection menu 500 can comprise a mode selection dialog box 501 comprising a list of operating modes 502. The list of operating modes 502 can comprise, for example, the aforementioned select digital album mode, download images mode, print images mode, and beam/receive images mode. In various embodiments, the list of operating modes 502 can comprise individual mode selection links or icons such as, for example: Select Digital Album 511, Browse Images 512 (Accessed through Select Digital Album (SDA) mode), Zoom 513 (Accessed thought Browse mode 512), Download Images/Album to Photobook 514, Print Images 515, Beam/Receive images through Infrared port 516, and Power Off 517. In various embodiments, the Zoom 513 can be accessible to the user when the electronic photo book 10 is in the Browse Images mode but not visible from the top level menu 500.

Upon user selection of the Select Digital Album mode 511, the processor 150 can enter the Browse mode in which the user can browse images for display. For example, in the Browse mode, the user can use the up down keys 134 to “zoom in” to one picture per screen or “zoom out” to 16 thumbnails per half 110, 111, with intermediate “picture-counts” of 8, 4, and 1 image(s) per half in between. An advanced user can use a combination of the navigation wheel 131 and the power/mode button 128 to designate different “picture counts” per north-south half 110, 111 of the display area 105 screen. The user is also provided the ability to shuttle through the images in an album according to the “picture counts” they established using the left/right keys 133. In various embodiments, each time one image is assigned to an entire display area screen 105, the processor 150 can be configured to output character-generated instructions 518 on how to change the orientation of the picture (landscape/portrait) or initiate an optical digital zoom of, for example, up to 5×. When the user wants to change albums, he/she may actuate the power/mode button 128 again and start the process over.

In various embodiments, whenever the power/mode button 128 is actuated by itself, the processor 150 can be configured to output the mode selection menu 500 and allow the user to select a different mode. Each mode selection, the processor 150 can be configured to output intuitive, easy-to-follow instructions 518 in the character generation dialog box 501.

Upon user selection of the Print Image mode 515, the processor 150 can enter the print mode in which the user can browse images for display. For example, a Print mode sequence can comprise the following user interactions with the electronic photo book 10 using the character generation dialog box 501:

a. Press Print/Mode button 128 from Browse mode.

b. Highlight an select “Print Images” as instructed.

c. Highlight and select “album(s) to get images” as instructed.

d. Highlight and select images from a thumbnail preview of images in albums.

e. Highlight and select “Complete selection” as instructed.

f. Highlight and select print images as a final action.

g. User is returned to browse mode, with a small character generated message in lower left corner: “Printing images”.

Upon user selection of the Download Images/Album to Photobook mode 514, the processor 150 can enter the download mode in which the user can receive images. For example, a Download Images/Album mode sequence can comprise the following user interactions with the electronic photo book 10 using the character generation dialog box 501:

a. User presses the Print/Mode button 128 either at start up or in the Browse mode.

b. User selects “Download Images”.

c. User highlights and selects one of the following options:
1. From Computer.
2. From digital camera memory card.
3. From other photobook.

d. User is asked to answer whether devices are correctly connected (USB Cable).

e. User is prompted to select from a list of available albums or images.

f. User is prompted to name new album using a character generated keyboard that appears on the default/selected dialog screen, or to select an existing album into which new album/images should be placed, or to keep albums or images as new, already named entities.

Upon user selection of the Beam/Receive Images mode 516, the processor 150 can enter the beam mode in which the user can output or receive images using the wireless interface 127. In various embodiments, the Beam/Receive Images mode sequence can comprise user interactions with the electronic photo book 10 using the character generation dialog box 501 similar to those described above with respect to the Download Images/Album to Photobook mode 514.

After user has finished with the photobook, the user can actuate the power/mode button 128 and select the Power Off mode 517. Upon user selection of the Power Off mode 517 selection, the processor 150 can be configured to power down the electronic photo book 10 and enter the power off state.

In various embodiments, the camera flash drive 129 can read and write data to and from a digital camera memory device such as, for example, the CompactFlash® 1MB flash storage device available from Lexar Media, Inc.

As shown in FIG. 2, the electronic photo book 10 can also comprise Read Only Memory (ROM) 170, Random Access Memory (RAM) 171, and non-volatile storage 172. In various embodiments, the ROM 170 can comprise, for example, a standard ROM device, a Programmable ROM (PROM), Erasable PROM (EPROM), Electrically-Erasable PROM (EEPROM). In various embodiments, the non-volatile storage 172 can comprise a hard disk drive or other non-volatile storage device. Programmed instructions can be stored or maintained in non-volatile storage 172, ROM 170, or a combination thereof, or may be received from a network via the wireless interface 127. Instructions may be loaded into RAM 171 and/or various processor registers for execution by the processor 150. When executed by the processor 150, the instructions can cause the processor 150 and electronic photo book 10 to be configured to perform operations specified by the instructions.

As discussed earlier herein, the processor 150 can comprise any microprocessor or microcontroller configured to execute software instructions implementing the functions described herein. Application executable instructions/APIs and operating system instructions may be stored using non-volatile memory 172 or ROM 170, and then loaded into volatile memory or RAM 171 for execution. Application executable instructions/APIs can comprise software application programs implementing software portions of the electronic photo book 10. The instructions can comprise operating system instructions to provide basic operation and control of the processor 150. In various embodiments, operating system instructions can comprise a version of the Windows™ operating system available from Microsoft Corporation of Redmond, Wash. Other embodiments are possible. For example, the Linux operating system available from Redhat Systems, Inc. of Raleigh, N.C. may be used.

In various embodiments, application executable instructions/APIs can comprise a sequence of Visual Basic™ or C/C++ instructions. Application executable instructions/APIs can comprise one or more application program interfaces (APIs). The application program(s) can use APIs for inter-process communication and to request and return inter-application function calls. For example, an API can be provided in conjunction with the non-volatile memory 172 in order to facilitate the development of SQL scripts useful to cause the non-volatile memory 172 to perform particular data storage or retrieval operations in accordance with the instructions specified in the script(s). In general, APIs may be used to facilitate development of application programs which are programmed to accomplish the functions described herein.

In various embodiments, the components of the electronic photo book 10 as shown in FIG. 2 can be implemented using discrete electronic components mounted on a circuit board assembly 160. In various alternative embodiments, some or all of the components of the electronic photo book 10 as shown in FIG. 2 can be implemented using one or more Integrated Circuit (IC) devices including, for example, one or more Field Programmable Gate Arrays (FPGAs). The electronic photo book 10 components can be coupled to the processor using a bus (not shown).

Thus, in various embodiments, the electronic photo book 10 can download media, jpegs and mpegs, to non-volatile storage 172 associated with a processor 150 or small CPU in the spine 120. Pictures can be downloaded individually or as digital albums for browsing using the electronic photo book 10.

With respect to FIG. 4, there is shown a set of display controls 130 which a user can operate to cause the processor 150 to configure the displays 101 and 102 to output and manipulate photographs, pictures, or images according to different modes. As shown in FIG. 4, the user display controls 130 can comprise an up/down and left/right selection button 131. For example, the selection button 131 can comprise a four-direction circular spring-loaded button (for example, a navigation button or wheel) that sends a signal to the processor 150 indicating requested movement in the direction of the location on a unit circle corresponding to the location on the circular button 131 which is being actuated by the user. For example, depending on the current operating mode of the electronic photo book 10, the selection button 131 can comprise a tact switch such as the JS 1100 5-Position Joystick Navigation Switch available from E-Switch, Inc. of Brooklyn Park, Minn. In various embodiments, the up/down and left/right selection button 131 provides the user the capability to select a picture, photograph, or image to “zoom in” on; to optically or digitally “zoom in” on a particular portion of an image displayed in any one of the halves 110, 111 (or display quadrants); or to print, or to send to another electronic photo book 10 or other device such as, for example, but not limited to, a Personal Digital Assistant (PDA), or TV adapter. Further, user display controls 130 can comprise advance and retreat buttons 133 and quantity buttons 134. In various embodiments, the advance and retreat buttons 133 can allow a user to move forward and backwards through a digital album or entire library. The left and right quantity buttons 134 can allow the user to determine individually how many pictures will be displayed and viewed at a time in a display area 105. Further, in various embodiments, the up/down and left/right selection button 131 can also be used to scroll up and down in the information display 123 as well. Alternatively, the up/down and left/right select button 131 can comprise two or more separate buttons for effecting up, down, left, and right direction movement.

In various embodiments, a search capability can be provided to allow the user to search image files contained in non-volatile storage 172. For example, the processor 150 can be configured to output a list or index of images or image files using the information display 123. The images/files can be indexed by filename, for example, with a unique name assigned for each image. The processor 150 can also be configured to scroll up and down the list of images/files and select at least one image/file using the navigation button 131.

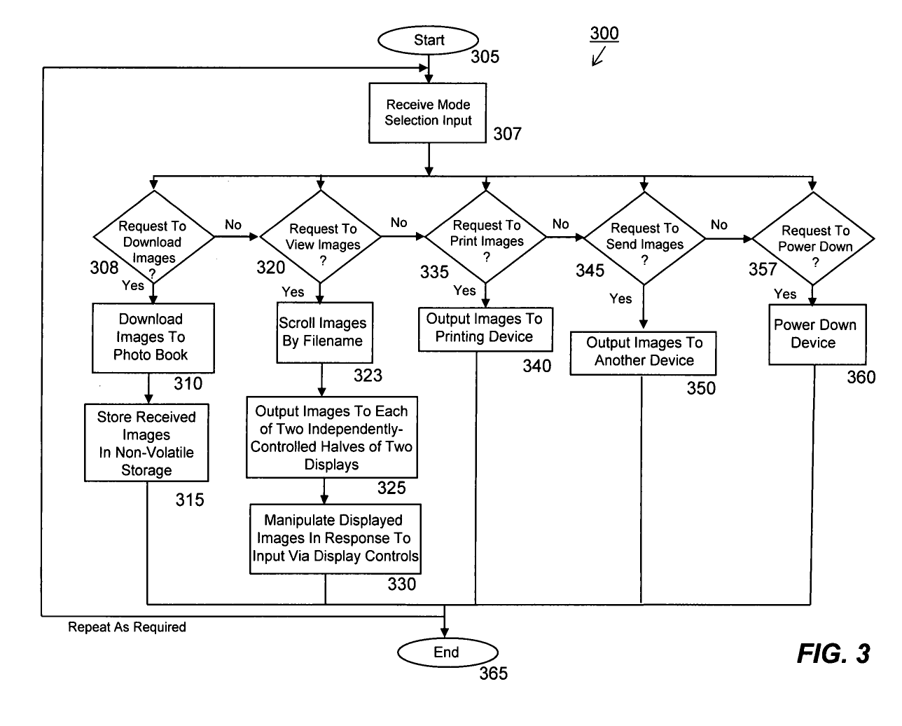

With respect to FIG. 3, there is shown a flow chart of a method 300 according to various embodiments. Various embodiments can commence at 305, from which the method can continue to 307. At 307, the method can comprise receiving a mode selection input. If the Download Images mode is selected or input at 308, then the method can proceed to 310. At 310, the method can comprise downloading one or more digitized images to an electronic photo book. The method can then proceed to 315, at which the method can comprise storing the received images using non-volatile storage. If the Browse mode is selected or input, then the method can then proceed to 320, at which the method can comprise receiving a request to view one or more images. From 320, the method can proceed to 323 at which the method can comprise outputting a list of image/file names to the information display 123 and receiving a request to view a particular image in response to user input received via display controls. Upon receiving a request to view a particular image, the method can then proceed to 325, at which the method can comprise outputting the requested images to each of two independently-controlled halves of two displays. The method can then proceed to 330, at which the method can comprise manipulating the images displayed on the halves in response to user input received via display controls. If the Print mode is selected or input, then upon receiving a request at 335 to print one or more images, the method can then proceed to 340. At 340, the method can comprise outputting the requested images to a printing device. If the Beam/Receive Images mode is selected or input, then upon receiving a request at 345 to send one or more images to another device or network, the method can then proceed to 350. At 350, the method can comprise outputting the requested images to another device using a wireless interface. Steps 320 through 350 can be repeated for successive actions in response to user requests received via the display controls. If the Power Off mode is selected or input at 357, then the method can proceed to power down the electronic photo book 10 at 360. The method can then proceed to 365, at which the method can end.

Thus has been shown an electronic photo book apparatus and method that provides the ease, comfort, and tradition of the photo album, as well as the space and money saving characteristics of digital imaging and the convenience and capacity available using electronics. Many digital albums can be stored in one electronic photo book, and there is no longer the need to print as many pictures because they can be displayed electronically at high quality. Further, when displaying images using the electronic photo book, users do not need to huddle around together to enjoy them. Many photo albums worth of information can be obtained from, for example, a scanner, and stored and displayed using the electronic photo book. Thus, embodiments can display high quality digital images in a manner that is technical but casual and easy to operate. Further, the electronic photo book is portable.

Embodiments are appropriate for a living room, parlor, or kitchen, while much less expensive than a high-resolution screen laptop. Embodiments can comprise means for manipulating the media more intuitively than using a PC or laptop. In addition, users do not necessarily require PC knowledge or proficiency to use the electronic photo book. Embodiments can be more intuitive and accessible than a PC, PDA, or IPOD™ photo device, and is therefore likely to be more inviting to older users, especially those who may not be comfortable using PCs, may not handle a mouse or track pad well, or may not see small images well.

While embodiments of the invention have been described above, it is evident that many alternatives, modifications and variations will be apparent to those skilled in the art. Accordingly, the embodiments of the invention, as set forth above, are intended to be illustrative, and should not be construed as limitations on the scope of the invention. Various changes may be made without departing from the spirit and scope of the invention. Accordingly, the scope of the present invention should be determined not by the embodiments illustrated above, but by the claims appended hereto and their legal equivalents.

What is claimed is:

1. An electronic photo book, comprising:
a first display coupled to a processor via a first display interface;
a second display coupled to the processor via a second display interface;
the first display and the second display each comprising a display area, at least two sides, and an exterior portion;
a spine comprising two sides and an exterior portion, wherein the spine is hingably connected to a first side of the first display along a first side of the spine and wherein the spine is also hingably connected to one side of the second display along a second side of the spine, wherein the exterior portions of the first and second displays and the spine are covered with a tactile material;
wherein the display area comprises a top half and a bottom half, the top half and the bottom half being independently controllable by the processor;
wherein the processor is disposed within the spine and is configured to output a digitized image to the top half and to the bottom half of the display area of the first and the second displays; and
a fold-in cushion inlay covered with a soft material, the fold-in cushion inlay hingably connected to a second side of the first display.

2. The electronic photo book of claim 1, further comprising:
an information display disposed in the spine.

3. The electronic photo book of claim 2, in which the information display is configured to output information associated with the photographs available for display.

4. The electronic photo book of claim 3, in which the information associated with the photographs comprises the number of albums available, the amount of storage space remaining available, and the remaining battery life.

5. The electronic photo book of claim 1, in which the tactile material is leather.

6. The electronic photo book of claim 1, further comprising:
a power port coupled to the processor and configured to receive power from an external source.

7. The electronic photo book of claim 1, further comprising:
a download port coupled to the processor and configured to receive digital information.

8. The electronic photo book of claim 1, further comprising:
a printer port coupled to the processor and configured to output digitized images to a printer.

9. The electronic photo book of claim 1, further comprising:
a wireless interface coupled to the processor and configured to output digitized images to an external display device.

10. The electronic photo book of claim 9, in which the wireless interface is an infrared interface.

11. The electronic photo book of claim 1, further comprising:
a camera flash drive.

12. The electronic photo book of claim 1, further comprising:
a fulcrum rod upon which the display area is rotationally mounted within the first display and second display.

13. A method for storing and outputting digitized images, comprising:
outputting a plurality of digitized images to each of two independently-controlled halves of two displays.

14. The method of claim 13, further comprising:
manipulating the images displayed on the halves in response to user input received via display controls.

15. The method of claim 13, further comprising:
outputting the images using a wireless interface.

16. The method of claim 13, wherein the images are digitized photographs.

17. An electronic photo book, comprising:
a first display coupled to a processor via a first display interface;
a second display coupled to the processor via a second display interface;
the first display and the second display each comprising a display area, a left side, and a right side, an exterior portion;
a fulcrum rod upon which the display area is rotationally mounted within the first display and second display;
a spine comprising two sides and an exterior portion, wherein the spine is hingably connected to the right side of the first display along a first side of the spine and wherein the spine is also hingably connected to the left side of the second display along a second side of the spine, wherein the exterior portions of the first and second displays and the spine are covered with leather;
wherein the display area comprises a top half and a bottom half, the top half and bottom half being independently controllable by the processor;
wherein the processor is disposed within the spine and is configured to output a digitized photograph to the top half and to the bottom half of the display area of the first and the second displays;
a fold-in cushion inlay covered with a soft material, the fold-in cushion inlay hingably connected to the left side of the first display;
an information display disposed in the spine and configured to output information associated with the photographs available for display comprising the number of albums available, the amount of storage space remaining available, and the remaining battery life;
a power port coupled to the processor and configured to receive power from an external source;
a download port coupled to the processor and configured to receive digital information;
a printer port coupled to the processor and configured to output digitized photographs to a printer;
a camera flash drive; and
an infrared interface coupled to the processor and configured to output digitized photographs to an external display device.

18. The electronic photo book of claim 17, further comprising:
a plurality of user controls coupled to the processor and disposed on the spine.

19. The electronic photo book of claim 17, wherein the digitized photographs are formatted in conformance with the Joint Photographic Experts Group standard.

20. The electronic photo book of claim 17, further comprising:
a power/mode button, wherein the processor is further configured to operate in accordance with one of a plurality of operating modes in response to actuation of the power/mode button.
